(19) United States
(12) Patent Application Publication
(10) Pub. No.: US 2017/0316690 A1
(43) Pub. Date: Nov. 2, 2017

(54) SYSTEMS AND METHOD FOR ESTIMATING AND COMMUNICATING PARKING LOT UTILIZATION

(71) Applicant: AssetWorks LLC, Wayne, PA (US)

(72) Inventors: Kevin Charles, Austin, TX (US); William T. Drake, Austin, TX (US)

(21) Appl. No.: 15/142,313

(22) Filed: Apr. 29, 2016

(51) Int. Cl. G08G 1/14; G08G 1/065; H04W 4/02; G06Q 10/02

(52) U.S. Cl. CPC G08G 1/144; H04W 4/023; G06Q 10/02; G08G 1/065; G08G 1/148

(57) ABSTRACT

There are systems and methods for estimating and communicating parking lot utilization for parking lots comprising receiving a parking prediction request at a first time comprising obtaining parking lot capacity, identifying associated buildings, determining a first set of potential parkers at the first time based on the associated buildings, obtaining a set of arrived parkers and an arrived parkers count from parking gate pass readers and subtracting an arrived parkers count from the parking lot capacity, getting, from the class server, a likely departing parkers count from the set of arrived parkers and adding the likely departing parkers count to the parking lot capacity and estimating a likely entering parkers count and adding the likely entering parkers count to the parking lot capacity and disseminating the set of parking lot utilizations.

### TECHNICAL FIELD

The disclosure relates generally to parking lots. More specifically it relates to a system and method for estimating parking lot utilization and communicating estimates of parking lot utilization to users.

### BACKGROUND

Meaningfully improving parking lot utilization and traffic flow within higher education institutions presents unique challenges technically, operationally, and financially. Those challenges include mandated or internal pressure to reduce their carbon footprint, ensuring constituents (students, staff, visitors) have ready access to parking, improving customer satisfaction, and continued operating expenses and capital expenditure reductions of parking management and infrastructure.

The crux of the issue, especially for large commuter campuses with unmonitored surface parking lots, is the large volume of vehicles that arrive/depart within relatively short windows of time; e.g., 20 minutes before/after classes throughout the day. These repeated, short time windows are encountered largely by the same population though on varied days (e.g. Monday-Friday) according to their class schedules. In short, a lot of people are looking for parking spots at roughly the same time(s) day in and day out. An answer to mitigate the parking crunch is to advertise lot availability to seekers. Institutions today attempt to mitigate pressured parking in a variety of ways including: parking attendants, in-ground “hardware loops” that monitor/report lot capacity, car counting camera systems, crowd-sourced based mobile apps, and lot entrance/exit gates that relay utilization via signage and/or consumer mobile apps. Such systems require substantial, upfront cost, intrusive construction, additional physical maintenance, and/or increase labor spend. Crowd-sourced apps also run the risk of being untrustworthy and may not be up to date.

As such, improvements to address such problems are desirable.

### SUMMARY OF THE DISCLOSURE

There is a system for estimating and communicating parking lot utilization for a set of permit parking lots comprising: a parking server configured to: receive a parking prediction request for a set of parking lot utilizations for a set of parking lots at a first time; and for each parking lot in the set of parking lots: obtain a parking lot capacity data; identify associated buildings; determine from a class server, a potential parkers count at the first time based on the associated buildings and subtract the potential parkers count from the parking lot capacity data; get, from the class server, a likely departing parkers count at the first time and add the likely departing parkers count to the parking lot capacity data; set the parking lot utilization based on the parking lot capacity data; and add the parking lot utilization to a set of parking lot utilizations; and disseminate, to a parking data sink device, the set of parking lot utilizations in response to the parking prediction request; and a class server configured to: determine a potential parkers count at the first time based on the associated buildings and provide the potential parkers count to the parking server; get a likely departing parkers count at the first time and provide the likely departing parkers count to the parking server.

The set of parking lots may further comprise permit parking lots and each potential parker in the potential parkers count may have a permit to at least one of the parking lots in the set of parking lots.

The system may further comprise a parking gate permit reader configured to: read permits prior to granting entry to a permit parking lot; and communicate the current parkers count to the parking server; and the parking server may be further configured to subtract the current parkers count from a total parking lot capacity.

The potential parkers count may further comprise a set of students that each have classes in the associated buildings with a start time within a threshold time of the first time.

The set of students may further each have a user device that may be moving towards the parking lot within a threshold time of the first time.

The departing parkers count may further comprise a second set of students with last classes with an end time within a second threshold time of the first time.

The system may further comprise a user device, comprising a mobile application configured to send, to the parking server, the parking prediction request, the set of parking lots, and the first time, wherein the first time is an estimated arrival time from a geo-locating system on the user device.

The parking lot capacity data may further comprise a number of available spaces, acquired from a parking detection system that communicates the number of available spaces to the parking server.

There may further be a parking data sink device configured to: receive the set of parking lot utilizations in response to the parking prediction request; and display the set of parking lot utilizations according to the parking data sink device characteristics.

There is also a method for estimating and communicating parking lot utilization for a set of permit parking lots comprising: receiving a parking prediction request for a set of parking lot utilizations for a set of parking lots at a first time; for each parking lot in the set of parking lots: obtaining, at a parking server, a parking lot capacity data; identifying, by a parking server, associated buildings; determining, from a class server, a potential parkers count at the first time based on the associated buildings and subtracting the potential parkers count from the parking lot capacity data; getting, from the class server, a likely departing parkers count at the first time and adding the likely departing parkers count to the parking lot capacity data; setting the parking lot utilization based on the parking lot capacity data; and adding the parking lot utilization to a set of parking lot utilizations; and disseminating, by the parking server to a parking data sink device, the set of parking lot utilizations in response to the parking prediction request.

The set of parking lots may further comprise permit parking lots and each potential parker in the potential parkers count may have a permit to at least one of the parking lots in the set of parking lots.

The obtaining may further comprise acquiring a current parkers count, from a parking gate permit reader that may read permits prior to granting entry to a permit parking lot and may communicate the current parkers count to the parking server, and the parking lot capacity data may comprise a total parking lot capacity less the current parkers count.

The potential parkers count may further comprise a set of students that each have classes in the associated buildings with a start time within a threshold time of the first time.

The set of students may further each have a user device that may be moving towards the parking lot within a threshold time of the first time.

The likely departing parkers count may further comprise a second set of students with last classes with an end time within a second threshold time of the first time.

The method may further comprise sending, from a mobile application on a user device, the parking prediction request, the set of parking lots, and the first time, wherein the first time may be an estimated arrival time from a geo-locating system on the user device.

The parking lot capacity data may further comprise a number of available spaces, acquired from a parking detection system that may communicate the number of available spaces to the parking server.

### BRIEF DESCRIPTION OF THE DRAWINGS

The disclosure is illustrated in the figures of the accompanying drawings which are meant to be exemplary and not limiting, in which like references are intended to refer to like or corresponding parts, and in which:

FIG. 1 is a diagram of the parking lot utilization estimation and communication system according to a non-limiting embodiment of the present disclosure;

FIG. 2 shows a schematic diagram of the computer system of FIG. 1 according to a non-limiting embodiment of the present disclosure;

FIG. 3 is a flowchart of a method for parking lot utilization prediction and communication to a subscriber according to a non-limiting embodiment of the present disclosure;

FIG. 4 is a flowchart of a method to generate a parking lot prediction for a subscriber according to a non-limiting embodiment of the present disclosure;

FIG. 5 is a screenshot of how parking lot utilizations may be displayed on a user device for a subscriber according to a non-limiting embodiment of the present disclosure;

FIG. 6 is a flowchart of a method for the parking lot utilization prediction and communication to the general public according to a non-limiting embodiment of the present disclosure;

FIG. 7 is a flowchart of a method to generate a parking lot prediction for the general public according to a non-limiting embodiment of the present disclosure; and

FIG. 8 is a screenshot of how a suggestion for the general public may appear on a user device according to a non-limiting embodiment of the present disclosure.

### DETAILED DESCRIPTION OF THE DISCLOSURE

Aspects of the present disclosure relate to systems and methods that collect and combine an institution's class schedules (and other class enrollment data and/or class schedule data such as class enrollment, enrolled students with parking passes and historical use of parking passes, individual students' daily class schedules and entry and exit times from parking lots using permits, and the like) working hours, purchased parking pass information, historic parking utilization, and other sources to estimate parking utilization.

The systems are further capable of estimating parking utilization and providing parking suggestions for individual user requests or can be set to run the estimation algorithms automatically at specified times or intervals for general users.

The parking availability information may be used in conjunction with interface screen “dashboards” that display computed parking suggestions, routes, and other pertinent information that facilitates users' navigation to an available parking lot or parking spot. For example a dashboard may display a campus map with an indicator of which parking lot or parking spot is the suggested parking option for the viewer of the screen/dashboard. The system may provide highly personalized lot information to identifiable users (subscribers). A subscriber may be a student at a higher education institution or any other driver who may want to receive parking lot utilization estimations. These and other features of the present disclosure may be realized upon further review of the following specification and the attached drawings.

Aspects of the system may be particularly helpful to institutions of higher learning, or other entities that control multiple parking lots, where parking lot utilization fluctuates throughout the year/month/week and day. The system implements software applications, based on various data obtained from disparate sources including parking sensing systems and class schedule data to predict and promulgate parking lot vacancies to potential drivers. This solution may benefit institutions that already have parking facilities that use deployed hardware sensing systems (“parking space detection systems”) via improved communication to drivers, complete lot coverage, and predictive lot utilization.

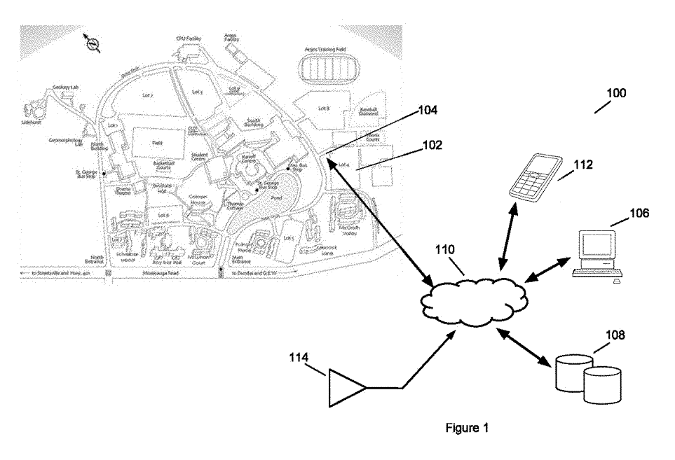

FIG. 1 is diagram of the parking lot utilization estimation and communication system 100 (“parking system”) comprising parking lot 102, gate 104, parking management computer or server 106, school servers 108, communication network 110, user device 112, and external data sources 114.

Parking system 100 may allow a parking authority to provide parking suggestions to individual requesters and via general requests for mass dissemination of parking lot capacity. They may thus increase the efficiency of parking, parking lot use, and hence revenue and customer satisfaction. Various data may be collected, such as via specialized hardware systems, combined with data (such as class schedules or known human patterns that affect parking such as train usage patterns for those having train passes, GPS locations and parking lot arrival times for drivers in vehicles requiring parking spaces, weather, road closures, queues at parking lots) and result in computed parking suggestions and routes to such parking suggestions.

Parking system 100 may receive a request (with various characteristics to describe the request, for example) and may provide a prediction relating to the request and its characteristics. For example, a request may be from a specific driver going to a specific location or having a known first class of the day. The parking prediction may thus be a parking lot 102 close to the location of the first class and that has capacity (or is predicted to have capacity, now or when the driver arrives). In another example a request may be for a general parking update. The parking prediction may thus be an ordering of the current (estimated or actual) capacity for the various lots being considered, for example presented in a table of descending predicted/actual parking spaces available. The terms “prediction” and “estimation/estimate” may be used interchangeably throughout this specification.

Parking lot 102 may be any commonly known parking lot or single/multiple level parking garage, which typically has a flat paved surface with a plurality of parking spaces indicated by a series of painted lines, and may have one or more gates 104. Parking lot 102 may be a permit parking lot, which may be accessible, such as via gate 104, by scanning or swiping a permit or a pass. Each permit may have a unique number or identifier (ID), such as a permit ID, and may be assigned to an individual student. Alternatively parking lot 102 may not have permits but may have various payment mechanisms (such as credit cards, cash, and the like), such as attached to gate 104 or separate therefrom, as known to those of skill in the art. Parking lot 102 may have one or more parking space detection systems, which may have the ability to identify and create metrics for occupied and unoccupied parking spaces. An exemplary parking space detection system may comprise parking lot 102 having one or more image capturing devices such as video cameras, which may be raised and mounted on poles or walls, and aimed at least at a portion of parking lot 102, which may provide automated or manually entered data regarding available spots (“parking space video device”). In another embodiment and another exemplary parking space detection system, parking lot 102 may include sensors positioned near parking spaces capable of detecting whether a car is parked in a parking space (“parking space sensor”). In yet another embodiment parking lot 102 may include a parking space detection system that has sensors to track vehicles entering and exiting the parking lot to be able to compute a known number of vehicles in a parking lot 102 having a particular number of parking spots. A higher education institution may have a number of parking lots of various sizes, adjacent to different facilities, and accessible via multiple roadways. In one embodiment, one or more parking lots 102 may allow access only to users who have been issued passes. In another embodiment, parking lot 102 may allow entry to any vehicle on a first come first serve basis.

Gate 104 may be one or more entrance and exit points that vehicles may pass through to gain access to parking lot 102. Gate 104 may be capable of tracking the number of vehicles entering and exiting parking lot 102 (either permit parking lots, by reading passes or non-permit parking lots, by counting the number of payments) and may be capable of tracking what vehicles/people/permits are entering and exiting as well. Gate 104 may include some aspects of an exemplary parking space detection system. Gate 104 may include one or more computers or processors (not shown) capable of communicating with other elements of the parking management computer 106 via the communication network 110. Gate 104 may include one or more permit or pass readers capable of scanning or reading a parking pass (not shown—parking gate permit reader) that may grant a vehicle entry into parking lot 102, such as via magnetic swipe, chip technology, RFID, QR codes, or the like. In one embodiment, the number of issued passes for a particular parking lot 102 may be known, and the pass reader may be capable of being tracked or monitored (such as by being able to communicate, via communication network 110, with other elements of system 100 such as parking management computer 106 and school servers 108) so that the reader is one form of parking space detection system. Parking gate permit reader may also send a list of scanned permit IDs to parking management computer 106. In another embodiment, the reader may accept a form of electronic or cash payment, for example a credit card acceptor.

Communication network 110 may be substantially any one or more public or private networks, wired or wireless, and may be substantially comprised of one or more networks that may be able to facilitate communication between themselves and between the various parts of system 100.

Parking management computer 106 (or “parking server”) may be one or more computers capable of running predictive parking lot management software. Parking management computer 106 may include one or more servers or databases (not shown) capable of ingesting and storing various data, such as for users who have subscribed for the parking service, weather and road information, parking information, information from other components of parking system 100, and the like. One of the one or more databases may be a user database which may contain preferences for each individual user. Parking management computer 106 may be located at the higher education institution campus or may be remote.

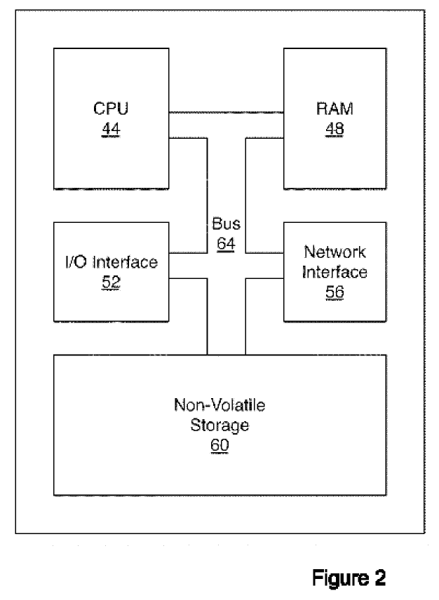

FIG. 2 shows various physical elements of the computers used in parking system 100, including parking management computer 106, school servers 108 and user device 112. As shown, the parking management computer 106 has a number of physical and logical components, including a central processing unit (“CPU”) 44, random access memory (“RAM”) 48, an input/output (“I/O”) interface 52, a network interface 56, non-volatile storage 60, and a local bus 64 enabling the CPU 44 to communicate with the other components. The CPU 44 executes an operating system and computer-executable instructions for implementing a parking lot management software platform as will be described. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network interface 56 enables communication with other systems. Non-volatile storage 60 stores the operating system, the computer-executable instructions for implementing the predictive parking lot management software platform and data stored and used by the predictive parking lot management software platform. During operation of the parking management computer 106, the operating system, the computer-executable instructions for implementing the predictive parking lot management software platform and the data may be retrieved from the non-volatile storage 60 and placed in RAM 48 to facilitate execution and access.

The embodiments of the systems and methods described herein may be implemented in hardware or software, or a combination of both. These embodiments may be implemented in computer programs executing on programmable computers, each computer including at least one processor, a data storage sys-tem (including volatile memory or non-volatile memory or other data storage elements or a combination thereof), and at least one communication interface. Program code is applied to input data to perform the functions described herein and to generate output information. The output information is applied to one or more output devices, in known fashion.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer usable instructions may also be in various forms, including compiled and non-compiled code.

It should also be noted that the terms coupled or coupling as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal or a mechanical element depending on the particular context. Furthermore, the term communicative coupling may be used to indicate that an element or device can electrically, optically, or wirelessly send data to another element or device as well as receive data from another element or device.

It should also be noted that, as used herein, the wording and/or is intended to represent an inclusive-or. That is, X and/or Y is intended to mean X or Y or both, for example. As a further example, X, Y, and/or Z is intended to mean X or Y or Z or any combination thereof.

The predictive parking lot management software may include a number of components and services. In particular, the predictive parking lot management software may include one or more software functionality modules (not shown) capable of performing at least the following functions: data gathering, parking prediction, parking suggestion, and communication. Parking management computer 106 may accumulate data from school servers 108 and external data sources 114 (which may include parking space detection systems) and may process or format the data so that it may be used to make a parking prediction. Parking management computer 106 may accumulate at least the following information:
Class schedules, including start times, end times, classroom location, and student enrollment
Staff and faculty work schedules, including start times, end times, and work locations
Parking lot permit data (permit types, lot type, payment type, hourly rates, parking pass purchased information)
Historical parking data
Parking lot capacity metrics, potentially from parking space detection systems
External data (weather, construction, accidents, public transit notices, on-campus events, or any other events that may affect roads or parking availability)
Driver history data
Driver behavior, such as collecting (via a driver's phone or the like) where the driver entered campus and where they ended up parking, which parking lots were visited without success, their navigation paths, speed while on campus and departure times from campus.

Using the data, parking management computer 106 may run one or more software applications to assess and/or predict parking lot 102 utilization.

Parking management computer 106 may use prediction data and user preferences stored in the user database to create suggestions, described herein, for individual users about which parking lot they should proceed to or avoid when using the parking service. Parking management computer 106 may predict when a user will arrive at parking lot 102 and may inform the user about potential parking lot capacity at that time.

Parking management computer 106 may create and send electronic message notifications to the general public (“public notifications”—such as to a website, radio service and other “general parking data sink devices”) and to subscribers (“subscriber notifications”—another parking data sink device, but an “individual parking data sink device”). The notifications may be a combination of text, tables, or graphics. The notification may inform the public generally, or may inform an individual user/subscriber, the following details for to parking lot 102:
a combination of the current number of occupied spaces, vacant spaces, and total spaces, expressed as whole numbers or as a percentage in utilization for example, 70 occupied spaces out of a total 100 spaces may mean 70% utilization;
expected number of occupied and vacant spaces throughout the day with accompanying times;
a time the lot is expected to reach full capacity;
next closest parking lot;
static parking lot details (hours, rates, directions);
special events user may want to know about; and
traffic conditions near parking lot or nearby roads.

School servers 108 may be one or more computers, databases, or data servers that store data specific to a particular higher education institution. School servers 108 may include a class server that stores data about class schedules, including but not limited to class start times, class end times, class locations, student enrollment data, and data related to modifications to regular schedules, for example cancellations and room changes. Student enrollment data may include a student enrollment database, which may contain information about individual students, for example name, student number, class list, etc. School servers 108 may store data related to staff and faculty work start times, end times, and work location.

School servers 108 may include a parking server (though they may also be separate), which may contain data and records about parking lot 102 (or otherwise have components or features of parking management server 106). For example, parking records may include information about the parking passes issued for parking lots 102, for example number of passes issued, space type (ADA, student, faculty, etc.), time of day restrictions, and eligible vehicles (compact, truck, etc.) Parking server may also contain a student parking database that may contain a list of students with permits to parking lots 102, and may contain other identifying information for each students for example name, student number, parking pass number/ID associated with at least one parking lot 102.

School servers 108 may have access to data about any other events that may affect the number of people attending a school campus, for example a special event occurring at the higher education institution.

Of course it is to be understood that various servers and functionality herein may be combined as desired, such as combining parking management server 106 with one or more school servers 108.

User device 112 may be computer or mobile device on which a user can receive a notification about parking lot 102, such as via a website or an application (“app”) on user device 112. User device 112 may be a parking data sink device. The characteristics of any parking data sink device may vary, for example parking data sink device may be a phone with a color (or black and white) display, a display of various dimensions or a computer monitor. In another embodiment parking data sink device may be a computer integrated with a radio broadcast or a website. Thus, based on the characteristics of the parking data sink device the parking lot utilizations may be displayed to be most advantageous (such as to avoid wrapping to a next line, and the like). The user, typically a driver who wishes to park in parking lot 102, may subscribe to an online service and may create preferences, for example which parking lots 102 he or she would like to receive notifications about and the method by which he or she would like to receive notifications, for example mobile application notification, email, SMS message, viewing on a website, etc. A user may subscribe to the online service through a website or by downloading an application from a mobile app store such as Google Play® or Apple® App Store (iOS). User device 112 may be capable of determining the GPS location of a user. The user may be a subscriber (hence may receive subscriber notifications) or a member of the general public (hence choosing to receive public notifications), or both.

When a user subscribes to the service, and becomes a subscriber, he or she may create an online account (or register and log into an app) and may be required to enter one or more of a name, email address, phone number, and student number. A subscriber may have additional benefits not available to members of the general public, for example receiving more specific information about parking lot 102 such as the rate or be able to specify what parking lots 102 to track, times to track, or patterns of checking utilization that appeals to the subscriber but may not be relevant for public notifications. The user may be able to customize preferences for the following:
Notification delivery method;
Notification frequency; and
Content of notification:
location preference: preferred lot and alternate lots—may be selected and ranked from a list, may be closest lot, cheapest lot, etc.
traffic, weather, special event notices, closures.

The user may enter a class schedule or timetable indicating what class locations they will attend at what times during the day, and potential parking lot preferences or provide access information (such as a student number and password) to school server 108 which may then provide the class schedule to user device 112 and the app.

User device 112 may have geo location services, for example GPS capability, wifi towers, etc., that may allow the location of user device 112 to be tracked and communicated to other elements of system 100. Geo location services may allow route suggestions to be received and followed, locations and timing to be determined, and the like. For example, an app on user device 112 may be used to request parking information, and GPS information may be included in the request to predict when the user will be nearing parking lots 102. The app may then receive a parking request response that indicates a lot to try, and the app may then use GPS functionality to confirm a path to parking lot 102 that is suggested. Of course a proposed path to parking lot 102 being suggested may also be provided to the app by parking system 100 (parking management computer 106 and its communication module).

User device 112 may be able to track, collect, and transmit driver history data to parking management computer 106, for example where the user entered campus, where the user ended up parking, which parking lots were visited without success, routes the user took, speed while on campus, arrival and departure times, etc.

User device 112 may be capable of holding an electronic parking pass capable of being scanned by gate 104 to gain access to parking lot 102.

Parking management computer 106 may also obtain GPS locations of one or more user devices 112 to determine users' parking lot utilization and how close a set of users are to parking. User device 112 may continuously send updates to the parking management computer 106, or updates may be sent at each request. In another embodiment there may be a “check-in” feature in a mobile application for a user to activate when he or she arrives at parking lot 102, with each parking lot 102 having a geocode associated therewith so that parking system 100 knows when a car is in a particular parking lot 102 at “check in” (thus embodying another form of parking space detection system or parking lot entry detection system, for example based on the granularity of the geo-locating technology).

External data sources 114 may be one more sources of data that affect road or parking conditions near the higher education institution and parking lot 102 or on the path from a user device 112 to campus (and/or a specific parking lot 102). External data may come from a wide variety of sources, both free and paid for services, for example traffic reports, accident reports, weather, construction, public transit incidents, special events, all of which may affect the number of cars on the road at any given time, the number of cars on a particular path for a user device 112, and parking lot capacity of one or more parking lots 102. Parking lot capacity (or capacity) may refer to the total number of available (unoccupied) spaces in parking lot 102. Total parking lot capacity may be the total number of spaces which may include both available spaces and occupied spaces. Some external data may be processed automatically by the parking management computer 106 and some external data may have to be manipulated manually by an operator to be processed by the parking management computer 106.

Method for Subscriber Notifications

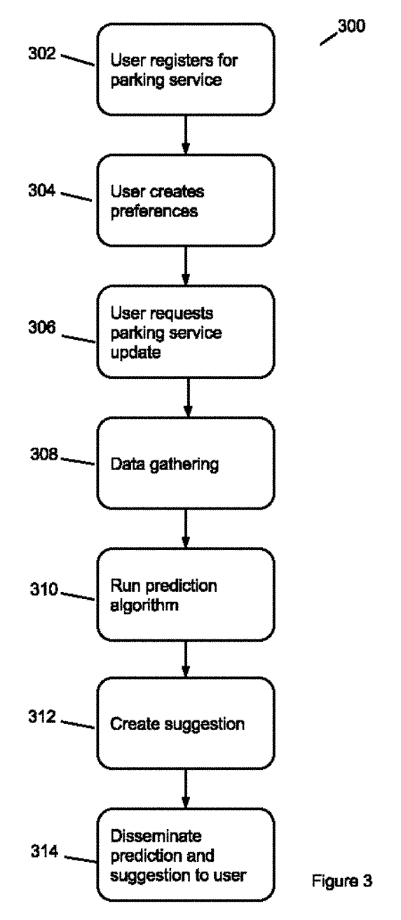

FIG. 3 is a flowchart of method 300 for parking lot utilization estimation and communication to a subscriber. Parking lot utilization may be a percentage of occupied parking spaces in a giving parking lot 102. For example where parking lot 102 has 100 total spaces and 75 are currently occupied vehicles, parking utilization is 75%, which lets a driver know 25% of the total number of spaces is free. In another embodiment, parking utilization may be expressed using whole numbers (e.g. 100, 75, 25), and presented as a combination of available parking spaces, occupied parking spaces, and/or total parking spaces, so long as a subscriber is given an estimate of the likelihood he or she will be able to find a parking space in parking lot 102. Utilization may also include text, such as “Full, “Nearly Full”, “Open”, “Widely Open” etc. which may correspond to particular percentages of utilization. Parking Utilization may be for a specific specified or estimated arrival time entered by the subscriber (or another future time, such as may be determined by a mobile application with geo-locating services), or for the current time. Such method may be used when a subscriber is heading to campus (and may be there at a particular time that the subscriber specifies or user device 112 allows system 100 to learn) and wants to know where to park, for example.

At 302 a user registers for the parking service. A user may install a mobile application or download software on user device 112. In another embodiment a user may register for a service on a website or through email. The higher education institution may inform its students and other users how to sign up for the service. The user may complete a registration process which may require entering information such as a valid email address, or phone number. In another embodiment user device 112 may be required to enter personal details related to the higher education institution such as school name, student name, student number or other identifier, vehicle license plate number, parking permit data, etc.

At 304 a user creates a profile, which may include parking preferences, and preferences for their notifications. Parking preferences may be entered by a user (e.g. ranking parking lot A above parking lot B) or may be automatically created and/or suggested to the user (for example, if the user's class schedule is obtained or entered then parking system 100 may, via app or parking management computer 106, specify the nearest parking lot to the location of the user's first class for each day of the week).

A user may also select one or more parking lots 102 from a list for which he or she would like to receive a notification. A user may also select alternate lots to be notified about should the preferred lot be full. Lot preference may be based on availability, location, price/rate, or a combination thereof. A user may be able to specify a parking lot 102 that is a reserved parking spot only if they have a permit or pass for such reserved parking lot 102 (which may be determined with reference to elements of the system described herein).

The user also may choose one or more delivery methods and a frequency for the notification. Delivery methods may be email, SMS message, alert etc. The frequency of receiving a notification may be on a per request basis or may recur at predetermined intervals.

What occurs at 302 and 304 may be largely setting up a user and/or user device 112, to use parking system 100. It is of course to be understood that generally such would only occur once, at setup, though changes could be made (and may be made, for example at the start of a new academic term).

At 306, a request for a parking prediction may be sent to parking management computer 106. The request may come from user device 112 at a predefined time set up in the preferences, for example, 30 minutes before a scheduled class. In another embodiment, the request may occur when the app is launched, when a user “clicks” or selects a key on user device 112, or the like. User device 112 then sends the request to parking management computer 106. The request may include various data, such as the location of the user device 112, the user's preferences, schedule (including where they wish to go when they depart parking lot 102), or specific preferences for that day (such as being willing to pay more to park closer on a cold day), and the like.

At 308, parking management computer 106 receives the request and collects data required to provide a parking prediction and suggestion. Along with the request the user device 112 may also send user details (described herein). The data collected may include, for example:
(a) data from school servers 108, such as:
   (i) the number of students enrolled in classes;
   (ii) the start times and end times of the classes;
   (iii) the locations of the classes (i-iii all will impact parking lot availability, typically parking lots closest to the classroom location are the first to fill up);
   (iv) historical data related to parking lot capacity; and
   (v) user details including preferences, driver movement history, user's parking permit data;
(b) data from parking detection systems (parking lot capacity data), such as:
   (i) the total number of available spaces (parking lot capacity);
   (ii) the total number of parking spaces, both available and occupied, (total parking lot capacity) for the lot; and
   (iii) parking gate permit reader data, which may include the number of vehicles that have entered the parking lot, and may include information to identify which students in a student parking database, parking server or class server have entered a particular parking lot 102.
(c) data from external data sources 114 such as:
   (i) special events or circumstances that affect attendance, for example changes to regular class schedules such as cancellations, or room changes occurring at the higher education institution;
   (ii) weather;
   (iii) road closures; and
   (iv) the number of drivers looking for a spot around the requested parking lot.

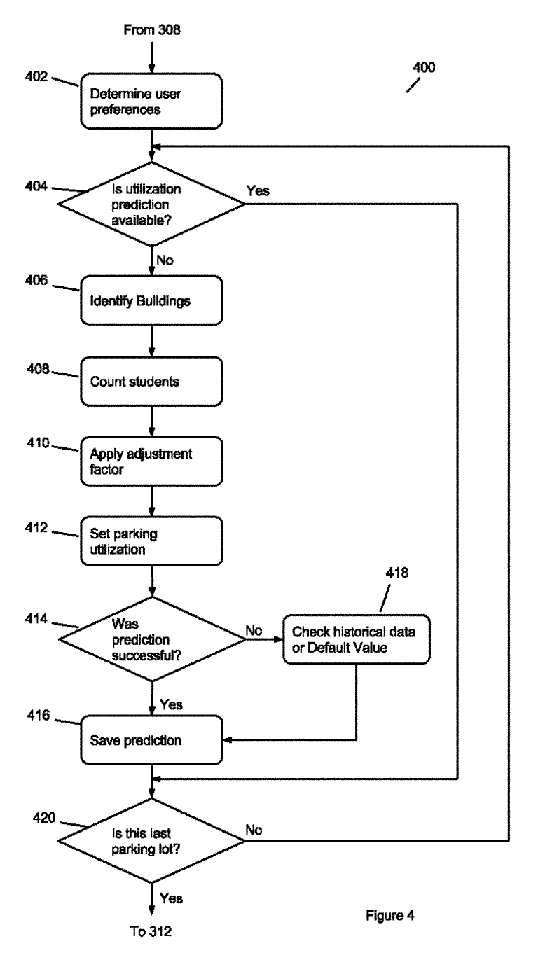

At 310, parking management computer 106 may run one or more software applications to generate a parking lot prediction for a subscriber (described herein as method 400 and shown in FIG. 4) for one or more parking lots 102 (such as those part of the user's preferences).

At 312 parking management 106 computer may create a suggestion for an individual user. This may involve combining user preferences with the capacities (estimated and/or actual) of the various parking lots 102. The best case scenario for a user would typically be the user's preferred lot. If the preferred lot is full or likely to be full when the user arrives at the school, parking management 106 may present alternate parking lot 102 details to the user. Factors to determine the alternate lots include, but are not limited to, availability, location, and hourly rate.

At 314 parking management computer 106 may disseminate the parking lot 102 utilization predictions and/or parking suggestion, to user device 112 or another parking data sink device. Suggestions may be customized for each individual user and may include a prediction (of capacities) and suggestion (of the best option, based on capacity and preferences). For example, the notification may include a message: “Lot A full. Alternate lots: Lot B, 50% full—$8.00/hour, Lot C 90% full—$5/hour.” Directions to the lots may also be provided, or GPS coordinates to their entrances, as part of disseminating the parking suggestion. In another embodiment, notifications may include the current and predicted parking lot 102 utilization and may include a message about anything affecting current and predicted availability, for example “Parking lot A expected to be full by 11:00 am because of sporting event at 12:00 pm.” Predicted parking lot utilization may be presented in text, tabular form, or graphic. The notification may also include a suggestion in the form of a text message instructing users to try an alternate parking lot 102 or an alternate route. Notifications may be sent via email, SMS, audio recordings (for hands-free), such as via user device 112.

FIG. 4 is a flowchart of method 400 to generate a parking lot prediction for a subscriber. Method 400 begins at 402 (having arrived there from 308) where a subscriber making the request is identified and the system may determine a list of which parking lots to check. The list of parking lots to check may be i) the parking lots listed in subscriber's preferences, ii) parking lots assigned to the subscriber's next class based on an estimated or specified arrival time or iii) all parking lots (which may be a default setting if i) or ii) are not applicable).

At 404, a check may be performed to see if a parking utilization prediction is already saved in a database for a specific or estimated arrival time, or a time close to the specific arrival time, for example within a 5 minute window. Parking utilization prediction may be an estimate of the number of parking spaces that will be occupied at parking lot 102 at a specific arrival time, for example 75% may mean 75 out of 100 spaces may be occupied at the specific arrival time. If yes, method 400 may proceed to step 418 to check whether this is the last lot in the list or whether to continue with the next lot. If a parking utilization prediction is not saved in the database, method 400 may proceed to step 406 to calculate a parking utilization prediction at the time requested (by way of example, that will continue to be described below, parking lot 102 ‘Lot A’, has 100 total spaces, where, for example 50 may be currently occupied, as determined by parking detection systems and 50 are unoccupied, or perhaps we just learn that Lot A has a total parking lot capacity of 100 spaces and/or a parking lot capacity of 50 spaces).

At 406, buildings associated with the current parking lot 102 may be identified. This may link, or allow to be linked, activities (classes, events, job locations, and the like) in those buildings with parking lot 102. Associating buildings to parking lot 102 at 406 may be done in advance or on the fly, it may be done manually by a user, or automatically via one or more rules (such as, “buildings with 500 meters on a sunny day”, “buildings within 1 km on game day”, and the like).

At 408, a student count (a form of “building user count” or potential parker count) may be initiated to count potential parkers, arrived parkers and likely departing parkers. Potential parkers may be people having a reason to be associated with a building identified in step 406, such as having a class in that building, for example at the relevant time or within a threshold time of the relevant time, and potentially whose past behavior indicates they are likely to come to park at a particular time. Arrived parkers may be people who have already parked and whose past behavior indicates they may be unlikely to leave before the requested time. Likely departing parkers may be people who are currently parked whose past behavior and/or class schedule indicates they may leave before a specific time requested.

The numbers of arrived parkers and likely departing parkers may be counted by parking management computer 106. Parking permit gate reader may send data to parking management computer 106 that may identify students, for example permit IDs and/or student numbers. Parking management computer 106 may then lookup students in the student enrollment database and student parking database to determine which students with permits have already arrived at a parking lot 102 and/or class server may be provided some of such data to be able to determine, and return to parking server, which students that are parked are likely to leave based on their class schedules. The student count may include three steps:

i) generating a “potential parkers count” using historical parking data and by counting all potential parkers for parking lot 102 with classes in the buildings identified where the classes start around the time requested and that have not ended, and where the system has not detected their arrival at any parking lot 102. (For example, 15 students with passes to Lot A are on their way to class starting at or near the arrival time, potential parkers count=15 (or the potential parkers count may be subtracted from parking lot capacity and/or total parking lot capacity); and

ii) generating an “arrived parkers count” or “current parkers” by counting all arrived parkers with registered arrivals but no departure from current parking lot 102 (which may be done via parking gate pass readers, parking space detection systems or location-finding technologies forming part of a mobile application, for example) and (optionally) whose previous behavior indicates they will not leave by the specified arrival time and add that to a running total. (For example, 10 students' past behavior indicates they stay late in Lot A, running total=15+10=25), though this step may be ignored, depending on details of the particular calculation, so as not to double count currently parked students/users; and

iii) generating a “likely departing parkers count” by counting all likely departing parkers with passes that will leave or are likely to leave before the specified arrival time and subtract that count from current running total. For example the likely departing parkers count may comprise students with last classes with an end time within a threshold time of the arrival time being considered (such threshold potentially being different than the threshold relating to potential parkers). This step may consider students' last class, past behavior (that indicates they are likely to depart, for example a history of leaving promptly or skipping their last class), or confirmation of drivers' departure by mobile app. (For example, 7 students will likely leave Lot A, running total=25−7=18, or the likely departing parkers count may be added to the parking lot capacity, indicating more spaces are expected to become available).

In another embodiment the student count may include generating a “current parkers count” by counting all parkers with registered arrivals but no departure from current parking lot 102 (which may be done via parking gate pass readers, parking space detection systems or location-finding technologies forming part of a mobile application, for example) and whose previous behavior indicates they will not leave by the specified arrival time. The current parkers count may then be subtracted from the total parking lot capacity to determine parking lot capacity.

Where parking lot 102 does not require a permit, similar steps may occur at 408 but detection may not be possible, though GPS readings and historical patterns may be used.

Of course other building user counts may exist, such as seats in a stadium, workers in a campus office, and the like.

At 410, an administration utilization adjustment factor may be added. This adjustment factor may allow a parking administrator to adjust parking utilization depending on external data such as weather, road closures, events, campus visits, and the like.

Steps 408 and 410 may be optimized by using previous driver behavior such as, whether the driver leaves parking lot 102 before the specified arrival time for the current day of the week, for example leaving class early on Friday, the last class of the day, previous arrival time, previous parking selection, driver's preference, and device information.

At 412, the potential parkers count may be subtracted from the parking lot capacity and the likely departing parkers count may be added to the parking lot capacity. A parking lot utilization prediction may be made using parking lot capacity and total parking lot capacity. In another embodiment, the current parkers count may be subtracted from the total parking lot capacity to calculate the parking utilization prediction, for example total parking lot capacity minus current parkers count equals parking lot capacity.

At 414, if prediction was successfully calculated, then continue to 416. The prediction is successfully calculated when i) there are no connection errors between some of the elements in the system and ii) when the prediction value is within an acceptable range, for example a positive value, or a percentage greater than zero and less than 100, or within some range specified by the higher education institution. If not, the method may proceed to 418 to check historical data. Checking historical data may comprise searching for a previous parking utilization prediction for a similar time period requested (for example the same day/time from the previous week). The historical parking utilization prediction may then be output instead of the calculated prediction, for example if there is strong reason to believe the currently calculated failure is not reliable. If no historical parking utilization prediction exists, the system may output a default value.

At 416, the parking utilization prediction for current parking lot 102 may be saved in a database on parking management computer 106 or school servers 108. The saved prediction may then be used for a subsequent driver making a similar request.

At 420, if the parking lot 102 is not the last lot in the list, method 400 returns to 402 and continues with next lot in the list. If the parking lot 102 is the last lot in the list, a list of parking utilization predictions may then be further filtered or sorted, based on subscriber preferences, in order to output a suggestion to the subscriber. The suggestion may include one or more parking utilization predictions for one or more parking lots 102.

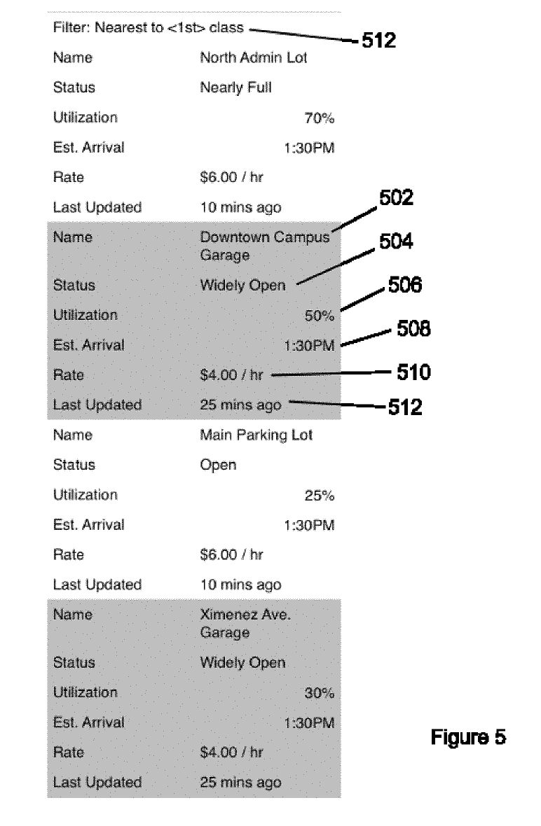

FIG. 5 is a screenshot of how a parking suggestion may be displayed on user device 112 for a subscriber. Parking suggestion may show the subscriber the parking utilization prediction as well as additional details. The suggestion may include a filter 512, estimated arrival time (determined, for example, using GPS locations of the parking lot 102 and the user's location and estimated drive times between the two), details of when a prediction was last updated 512, and details of parking lot 102 including: name 502, status 504, utilization in percentage 506, and rate 510. With reference to a screenshot such as shown in FIG. 5 a user may balance a status, cost, utilization and distance from his/her location to make a parking choice. For example a particular parking lot 102 may be closer to his/her class but nearly full and expensive so he/she might choose a farther parking lot 102 that has a better chance of being available and having an open spot. As shown, filters may be applied, such as “close to first class”. Other filters may include “near an exit from campus” or “near building 3”.

Method for General Public Notifications

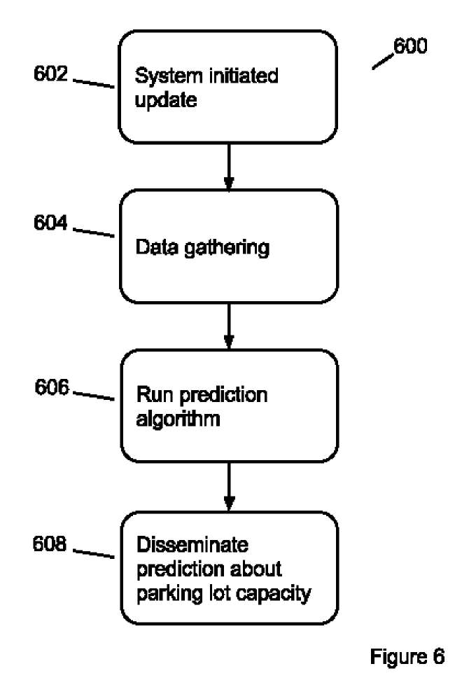

FIG. 6 is a flowchart of method 600 for the parking lot utilization estimation and communication to the general public. Method 600 may allow a parking lot capacity prediction/assessment to occur and for the results to be distributed to multiple people. Method 600 may of course be similar to method 300 in some respects.

At 602 a request for a parking prediction may be sent to parking management computer 106 (such as via one or more parking data sink devices such as a local radio station) or initiated by it (for example periodically or on a timed basis). The request may be initiated by the system in order to maintain up to date information or to make the information available generally. The request may include various data, such as preferences, what parking lots 102 to include, and the like.

At 604, parking management computer 106 collects data similar to step 308 in method 300.

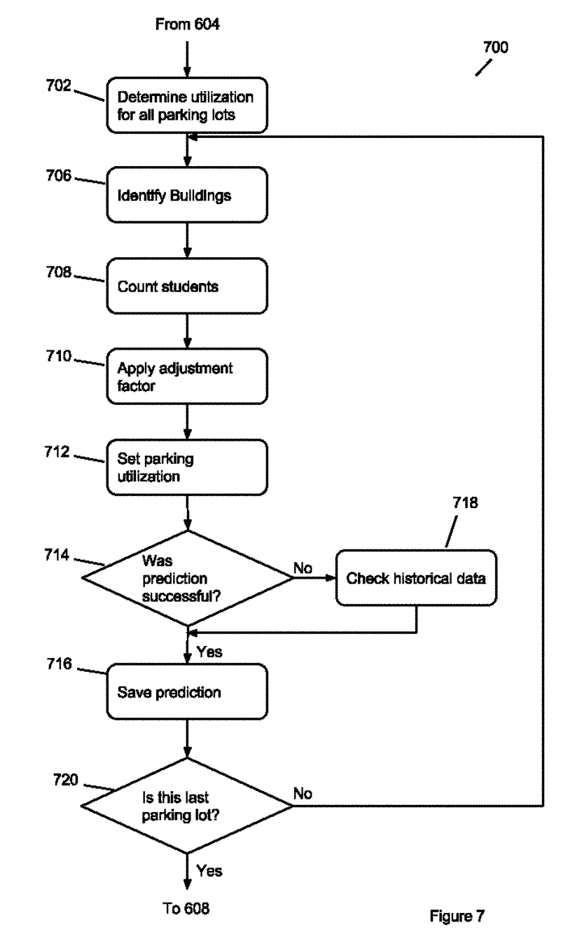

At 606, parking management computer 106 may run one or more software applications to generate a parking lot prediction for the general public (described herein as method 700 and shown in FIG. 7). The one or more software applications may make predictions about all parking lots 102 at the higher education institution or a subset thereof, for example as suggested by the request received.

At 608 parking management computer 106 may disseminate the parking lot 102 utilization predictions to one or more parking data sink devices. The parking utilization predictions may be made available to the public for free or for a subscription, or may be made available to all users of the system regardless of user preferences, for example, providing notifications on a website, mobile application, radio broadcast, or a mass email distribution list.

Parking utilization predictions may include the current and predicted parking lot 102 utilization for all parking lots 102 at the higher education institution and may include a message about anything affecting current and predicted availability, for example “Parking lot A expected to be full by 11:00 am because of sporting event at 12:00 pm.” Predicted parking lot utilization may be presented in text, tabular form, or graphic.

Parking management computer 106 may continuously monitor parking lot 102 and may be capable of receiving fresh data from school servers 108 or fresh external data 114 in real-time or at predetermined periods. Parking management computer 106 may continuously, or at pre-defined intervals, repeat the prediction and calculation and dissemination steps.

FIG. 7 is a flowchart of method 700 to generate a parking lot utilization prediction for the general public, or “multi-user”. Method 700 may of course be similar to method 400 in some respects. Method 700 begins at 702 (having arrived there from 604) where a request may be triggered to begin determining parking space estimate utilization for a list of parking lots 102 to check, which may include each parking lot 102 in the system. Method 700 may be triggered at predefined time intervals.

Steps 706 to 720 may be substantially similar to steps 406 to 420 of method 400 in FIG. 4.

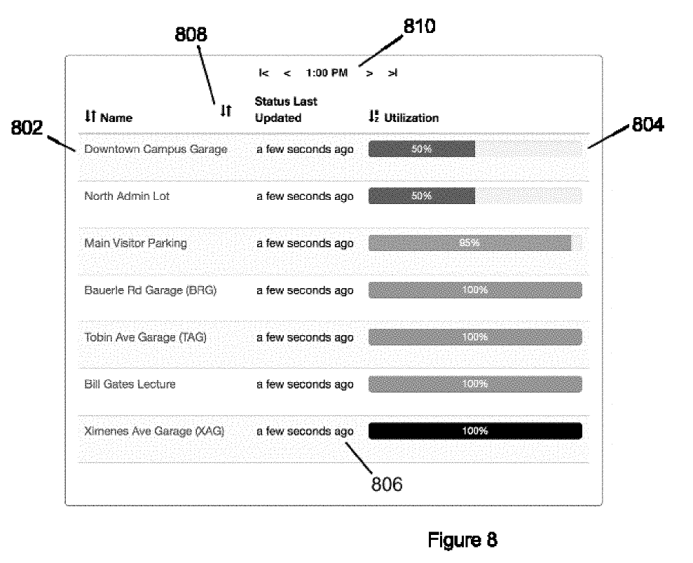

FIG. 8 is a screenshot of how parking lot 102 utilization predictions for the general public may be displayed on user device 112. The display may include one or more sorting options 808, and may show parking lot names 802, details of when the status was last updated 806, and utilization metrics 804, for a requested time 810. The parking utilization prediction for the general public may be the current time or may be for a specified arrival time or a combination thereof (for example to appeal to more people, or so parking data sink devices may be more relevant to more people). In addition utilization metrics may include current and estimated utilization metrics and such estimated utilization metrics may be for a given amount of time in the future (for example a half hour in advance, or based on how far from campus the user device 112 might be located or currently located).

In another embodiment, system 100 may make parking utilization predictions for parking lots 102 where passes are not required to gain access, but rather are open to the general public, which may or may not require payment to enter. For example, a parking lot that is free on weekends or holidays, and has parking space detection systems. Elements of methods 400 and 700 may still be able to count students who have arrived in parking lot 102, make predictions based on past behavior and apply an adjustment factor. Tracking mobile app usage may also be used to create estimates for parking lots 102 where passes are not required and may also thus may be another form of a parking space detection system or parking entry detection system. In another embodiment, a credit card or cash payment may be required to gain access to parking lot 102, and gate 104 may track vehicles entered by tracking credit card or cash transactions. In another embodiment a ticket may be issued by gate 104 instead of an up-front payment, and the ticket may need to be inserted when a driver exits parking lot 102. Where no passes exist for a parking lot 102 then associated buildings may still be counted, and resultant students may also be counted. However, the number of pass-carrying students may not be relevant but the number of students that may require parking may still be relevant. Further, the number of passes that have parked may not be relevant but payment data that may indicate a number of students that have parked may be relevant. And the historical exits may be used, as opposed to knowing when a currently parked student may leave (due to their class schedule), to estimate how many spots may open up before the relevant time. Thus it can be seen that although permits may create additional accuracy, non-permit parking lots 102 may also be used.

It will be apparent to one of skill in the art that other configurations, hardware etc. may be used in any of the foregoing embodiments of the products, methods, and systems of this disclosure. It will be understood that the specification is illustrative of the present disclosure and that other embodiments within the spirit and scope of the disclosure will suggest themselves to those skilled in the art. All references cited herein are incorporated by reference.

The aforementioned embodiments have been described by way of example only. The disclosure is not to be considered limiting by these examples and is defined by the claims that now follow.

1. A system for estimating and communicating parking lot utilization for a set of permit parking lots comprising:
a parking server configured to:
receive a parking prediction request for a set of parking lot utilizations for a set of parking lots at a first time; and
for each parking lot in the set of parking lots:
obtain a parking lot capacity data;
identify associated buildings;
determine from a class server, a potential parkers count at the first time based on the associated buildings and subtract the potential parkers count from the parking lot capacity data;
get, from the class server, a likely departing parkers count at the first time and add the likely departing parkers count to the parking lot capacity data;
set the parking lot utilization based on the parking lot capacity data; and
add the parking lot utilization to a set of parking lot utilizations; and
disseminate, to a parking data sink device, the set of parking lot utilizations in response to the parking prediction request; and
a class server configured to:
determine a potential parkers count at the first time based on the associated buildings and provide the potential parkers count to the parking server;
get a likely departing parkers count at the first time and provide the likely departing parkers count to the parking server.

2. The system of claim I wherein the set of parking lots comprises permit parking lots and each potential parker in the potential parkers count has a permit to at least one of the parking lots in the set of parking lots.

3. The system of claim 2 further comprising a parking gate permit reader configured to:
read permits prior to granting entry to a permit parking lot; and
communicate the current parkers count to the parking server; and
the parking server is further configured to subtract the current parkers count from a total parking lot capacity.

4. The system of claim 3 wherein the potential parkers count comprises a set of students that each have classes in the associated buildings with a start time within a threshold time of the first time.

5. The system of claim 4 wherein the set of students further each have a user device that is moving towards the parking lot within a threshold time of the first time.

6. The system of claim 4 wherein the likely departing parkers count comprises a second set of students with last classes with an end time within a second threshold time of the first time.

7. The system of claim 1 further comprising a user device, comprising a mobile application configured to send, to the parking server, the parking prediction request, the set of parking lots, and the first time, wherein the first time is an estimated arrival time from a geo-locating system on the user device.

8. The system of claim 2 wherein the parking lot capacity data comprises a number of available spaces, acquired from a parking detection system that communicates the number of available spaces to the parking server.

9. The system of claim 1 further comprising the parking data sink device configured to receive the set of parking lot utilizations in response to the parking prediction request; and display the set of parking lot utilizations according to the parking data sink device characteristics.

10. A method for estimating and communicating parking lot utilization for a set of permit parking lots comprising:
receiving a parking prediction request for a set of parking lot utilizations for a set of parking lots at a first time;
for each parking lot in the set of parking lots:
obtaining, at a parking server, a parking lot capacity data;
identifying, by a parking server, associated buildings;
determining, from a class server, a potential parkers count at the first time based on the associated buildings and subtracting the potential parkers count from the parking lot capacity data;
getting, from the class server, a likely departing parkers count at the first time and adding the likely departing parkers count to the parking lot capacity data;
setting the parking lot utilization based on the parking lot capacity data;
and adding the parking lot utilization to a set of parking lot utilizations; and
disseminating, by the parking server to a parking data sink device, the set of parking lot utilizations in response to the parking prediction request.

11. The method of claim 10 wherein the set of parking lots comprises permit parking lots and each potential parker in the potential parkers count has a permit to at least one of the parking lots in the set of parking lots.

12. The method of claim 11 wherein the obtaining further comprises acquiring a current parkers count, from a parking gate permit reader that reads permits prior to granting entry to a permit parking lot and communicates the current parkers count to the parking server, and the parking lot capacity data comprises a total parking lot capacity less the current parkers count.

13. The method of claim 12 wherein the potential parkers count comprises a set of students that each have classes in the associated buildings with a start time within a threshold time of the first time.

14. The method of claim 13 wherein the set of students further each have a user device that is moving towards the parking lot within a threshold time of the first time.

15. The method of claim 13 wherein the likely departing parkers count comprises a second set of students with last classes with an end time within a second threshold time of the first time.

16. The method of claim 10 further comprising sending, from a mobile application on a user device, the parking prediction request, the set of parking lots, and the first time, wherein the first time is an estimated arrival time from a geo-locating system on the user device.

17. The method of claim 10 wherein the parking lot capacity data comprises a number of available spaces, acquired from a parking detection system that communicates the number of available spaces to the parking server.

18. The method of claim 10 further comprising displaying, by the parking data sink device, the set of parking lot utilizations according to the parking data sink device characteristics.
